(19) United States
(12) Patent Application Publication
(10) Pub. No.: US 2009/0074423 A1
(43) Pub. Date: Mar. 19, 2009

(54) Method and apparatus for configuring an optical network terminal

(75) Inventors: Marc R. Bernard, Miramar, FL (US); Joseph C. Roesch, Herndon, VA (US); Charles E. Rothrauff, Sterling, VA (US); Douglas A. Atkinson, Ashburn, VA (US); Guy M. Merritt, Purcellville, VA (US); David H. Liu, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/002,318

(22) Filed: Dec. 14, 2007

Related U.S. Application Data
(60) Provisional application No. 60/994,100, filed on Sep. 17, 2007.

(51) Int. Cl. H04B 10/00

(52) U.S. Cl. 398/135

(57) ABSTRACT

Separating Passive Optical Network (PON) functions in different mechanical devices, such as optical to electrical conversion of the PON protocol, allows installation of an optical termination device at an exterior of an installation premises and installation of a user interface device performing PON functions inside the installation premises. Various embodiments allow service providers first to install an optical device outside the premises and, later, to install an electrical device, optionally by a customer. This eliminates a service provider from entering the installation premises and enables the customer to complete installation in the interior of the installation premises. Further, more robust, hardened components may be used in the more-permanently installed exterior device, while less-expensive, lower-quality components may be used in the easily-replaceable indoor device, thus reducing cost.

### RELATED APPLICATION(S)

This application claims the benefit of U.S. Provisional Application No. 60/994,100, filed on Sep. 17, 2007. The entire teachings of the above application are incorporated herein by reference.

### BACKGROUND OF THE INVENTION

A Fiber-to-the-Premises (FTTP) network architecture extends optical fiber directly to subscribers' premises. According to the FTTP network architecture, an Optical Network Terminal (ONT) is placed on the subscribers' premises, typically inside the premises. In a typical FTTP deployment, a single network element, such as an Optical Line Terminal (OLT), in a Central Office (CO) may monitor and manage active components of hundreds, thousands, or millions of ONTs. However, service providers employing the FTTP network architecture experience high costs in bringing optical fiber to subscribers' premises. Further, lengthy installation, itself, at the customer premises is very expensive to the service provider and disruptive to the customer.

### SUMMARY OF THE INVENTION

A method and corresponding apparatus for configuring an Optical Network Terminal (ONT) conducts physical layer ranging of the ONT with an upstream device, such as an Optical Line Terminal (OLT), and detects presence of a downstream device configured to support transport layer communications with the upstream device and user interface communications with end user devices. Optical signals are terminated, supporting communications of configuration data between the upstream device and downstream device. A configuration state of the ONT is changed based on configuration data initiated by the upstream device but presented by the downstream device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example network in which example embodiments of the present invention may be employed.

FIG. 2 is a diagram of an example embodiment of the present invention in which an Optical Network Terminal (ONT) is physically divided into a Network Interface Device (NID) and a User Interface Device (UID).

FIGS. 3A-3F are diagrams illustrating example embodiments of the present invention in which a composite cable carries data, voice and video signals, as well as various arrangements of electrical power.

FIGS. 4A-4C are diagrams illustrating different types of packages used in example embodiments of the present invention.

FIGS. 5A-5C are flow diagrams illustrating example methods by which an example ONT according to the present invention may be configured.

FIG. 6 is a block diagram illustrating an example apparatus for configuring an example ONT according to the present invention.

### DETAILED DESCRIPTION OF THE INVENTION

A description of example embodiments of the invention follows.

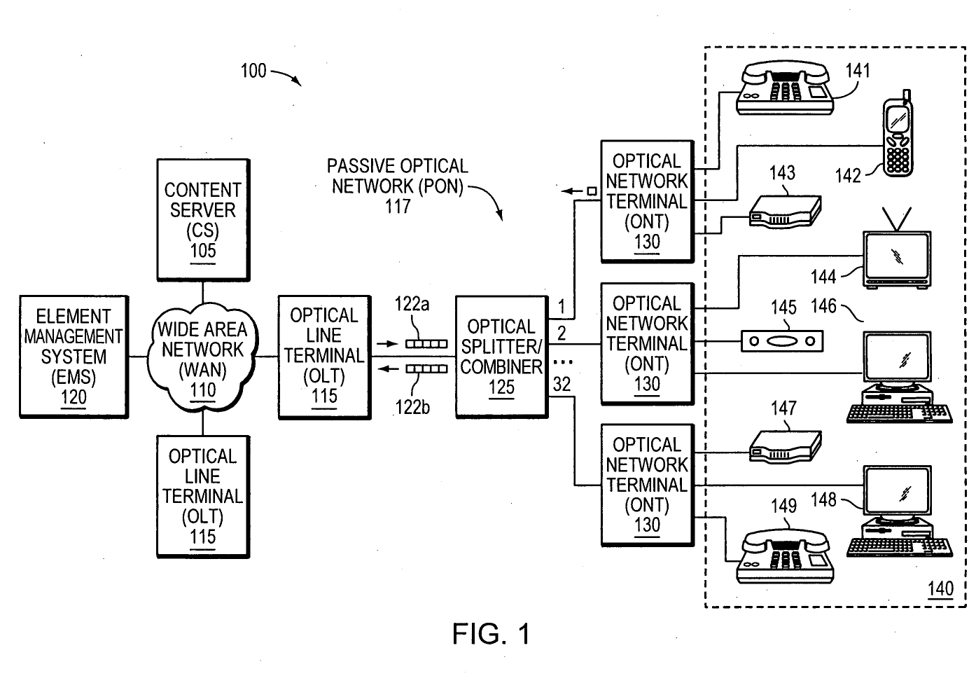

FIG. 1 is a block diagram of an example network 100 in which example embodiments of the present invention may be employed. The network 100 includes a Wide Area Network (WAN) 110 and a Passive Optical Network (PON) 117. The WAN 110 may be a network such as the Internet, and the PON 117 is typically a more localized network in which optical signals, used to transmit information, traverse passive optical elements, such as splitters and combiners, to be communicated between network nodes.

The example network 100 of FIG. 1 includes one or more Optical Line Terminals (OLTs) 115, an Element Management System (EMS) 120, and a Content Server (CS) 105, all connected, generally, by the WAN 110. In the example network 100, each OLT 115 transmits/receives information in the form of a frame of packets 122a, 122b embodied on optical signals to/from an optical splitter/combiner (OSC) 125 to communicate with, for example, thirty-two Optical Network Terminals (ONTs) 130. Each ONT 130 receives primary power by local alternating current (AC) power 132 at respective points of installation. The ONTs 130 provide connectivity to customer premises equipment 140 that may include standard telephones 141, 149 (e.g., Public Switched Telephone Network (PSTN) and cellular network equipment), Internet Protocol (IP) telephones 142, network routers 143, 147, video devices (e.g., televisions 144 and digital cable decoders 145), computer terminals 146, 148, digital subscriber line connections, cable modems, wireless access devices, as well as any other conventional, newly developed, or later developed devices that may be supported by the ONT 130.

ONTs 130 may be equipped with batteries or battery backup units (BBUs), interchangeably referred to herein as BBUs. In an event an ONT 130 equipped with a BBU experiences an interruption in primary power (e.g., local AC power 132), the ONT 130 may enable the BBU or otherwise accept receipt of power form the BBU to maintain services until the primary power source is restored or the BBU is drained of stored energy.

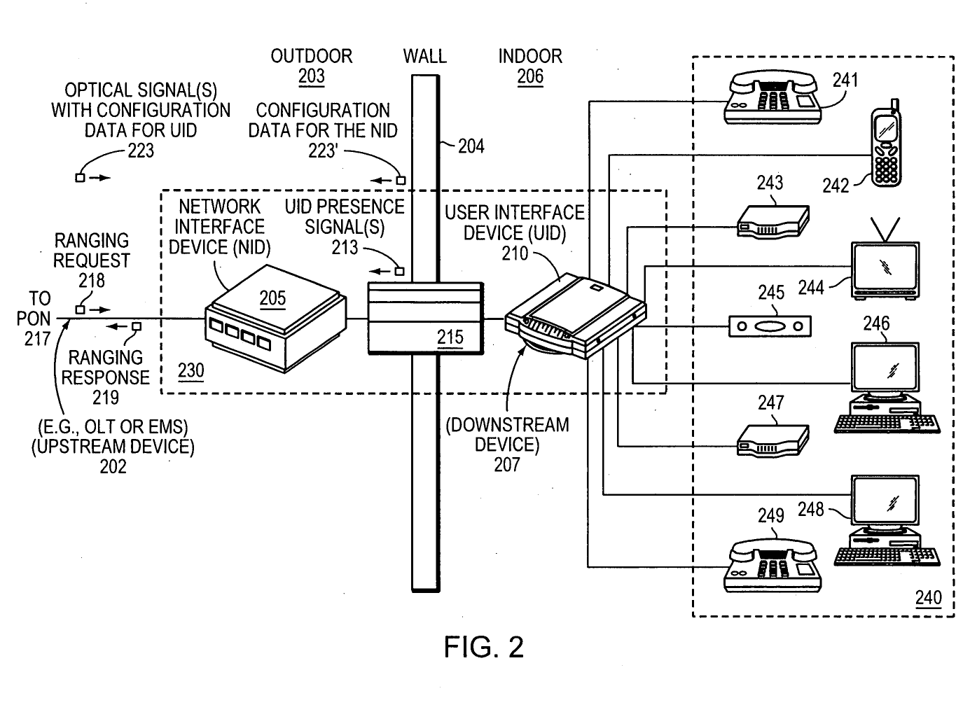

FIG. 2 is a diagram of an example embodiment of the present invention in which an ONT 230 is physically divided into a Network Interface Device (NID) 205, located in the outdoor 203 of a customer premises, and a User Interface Device (UID) 210, located in the indoor 206 of the customer premises. Many service providers are reluctant to incur the cost of installing optical fiber cables to numerous installation locations and prefer that ONTs 230 remain outside 203 customer premises. In example embodiments of the present invention, the NID 205 performs an optical to electrical conversion for downstream data for processing by the UID 210 and an electrical to optical conversion for upstream data from the UID 210. Further, the NID 205 may provide electrical power to the UID 210, including battery backup power when AC main power becomes unavailable.

A composite cable 215 may be connected through a wall 204 of a customer premises between the NID 205 and the UID 210 to carry electrical power as well as the service provider's data payload, including voice, data, video, physical layer information, such as converted Physical Layer Operations, Administration and Maintenance (PLOAM) cells or special protocol packets, and management data, such as ONT Management Control Interface (OMCI) channel data and upgrade data.

The NID 205 facilitates communications between an upstream device 202 (e.g., OLT 115 of FIG. 1), not shown, of the PON 217 and a downstream device 207 (e.g., UID 210). The ONT 230 is configured by conducting physical layer ranging, including a ranging request 218 and a ranging response 219, with the upstream device 202. Then the NID 205 detects 213 the presence of the downstream device 207 configured to support transport layer communications with the upstream device 202 and user interface communications with end user devices 240. The NID 205 then terminates optical signals from the PON 217 to support communications of configuration data 223 between the upstream device 202 and the downstream device 207. After terminating optical signals, the NID 205 changes a configuration state based on the configuration data 223 initiated by the upstream device 202 but presented 223′ by the downstream device 207. The NID 205 also may transmit the configuration data 223 from an outdoor environment 203 to an indoor environment 206 with respect to a premises where the end user devices 240 are located.

The physical layer ranging request 218 and a ranging response 219 may be performed automatically, or responsive to testing the downstream device 207. Further, detecting the presence of the downstream device 207 and changing the configuration state may be separated in time from the physical layer ranging. An ONT Management Control Interface (OMCI) channel also may be established. A second downstream device different from the downstream device may be detected, after which the OMCI channel must be reestablished with the second downstream device. The ONT 230 may change the configuration state based on further configuration data initiated by the upstream device 202, to configure an upgraded downstream device 207, but presented by the upgraded downstream device 207. The NID 205 may receive electrical power via the downstream device 207 or independent of the downstream device 207.

The NID 205 may convert data from an optical domain to an electrical domain and transmit the data via a non-fiber medium to the downstream device 207 to support data flow from the upstream device 202 to the end user devices 240. The NID 205 also may report a state of the downstream device 207 in an event of a fault associated with the downstream device 207, the fault including communications failure with the downstream device 207.

Example embodiments of the present invention allow various installation models, such as terminating the optical functions of the PON 217 outside 203 the installation premises at the NID 205 and transmitting the functions over a less-expensive medium, such as a copper interface of an existing coaxial cable, into the indoor 206 of the installation premises via a wall 204, for example, to the UID 210. This example embodiment allows easy upgrades of the UID 210, which is more likely than the NID 205 (containing the PON interface) to change over time as new technologies are released. Further, a NID 205 intended for outdoor installation may be manufactured using more-robust, hardened components to withstand harsh outdoor environments, with an interior UID 210 using less-expensive, non-hardened components.

Such installation models may reduce installations costs, both monetary and temporal. For example, a service provider may first install the NID 205 at the outside of a home. Later, a home owner may perform self-installation of the UID 210 so that the service provider may avoid entering the home altogether.

If there are problems with the NID 205, the UID 210 first detects them and then reports the problems to the EMS (e.g., EMS 120 of FIG. 1) via a notification, such as a hardware failure alarm. The UID 210 also performs all ranging functions and all physical layer functions, such as generation of PLOAM messages, recognizing downstream data that is destined for the UID 210, and other functions performed by a traditional ONT (e.g., ONT 130 of FIG. 1). The NID 205 may perform the physical layer functions and convert data to relevant flows that the UID 210 may distinguish as voice, data, video, etc. The UID 210 may then convert these signals to the proper format and forward them to their respective devices 240, include standard telephones 241, 249 (e.g., Public Switched Telephone Network (PSTN) and cellular network equipment), Internet Protocol (IP) telephones 242, network routers 243, 247, video devices (e.g., televisions 244 and digital cable decoders 245), computer terminals 246, 248, digital subscriber line connections, cable modems, wireless access devices, as well as any other conventional, newly developed, or later developed devices that may be supported by the ONT 230.

A service provider may manage the NID 205 and UID 210 as a single logical ONT 230 or, alternatively, as separate devices 205, 210. Logical management of the NID 205 and UID 210 as a single ONT 230 is beneficial to service providers that currently deploy traditional ONTs (e.g., ONT 130 of FIG. 1) with all functions integrated in one device but want to transition to the use of NIDs 205 and UIDs 210. However, there may be cases in which the NID 205 and UID 210 may be managed as separate devices. For example, a service provider may install the NID 205 before installing the UID 210, but may want to communicate with and range the NID 205 without use of the UID 210.

In example embodiments of the present invention, an EMS/OLT (e.g., EMS/OLT 120, 115 of FIG. 1) may manage with the NID 205 and UID 210 in a number of different ways: the EMS/OLT may communicate with the NID 205, which may act as a proxy for both the NID 205 and the UID 210 (i.e., the NID 205 and UID 210 are managed logically as a single ONT 230), or the EMS/OLT may communicate with the UID 210, which may act as a proxy for both the NID 205 and the UID 210 (i.e., the NID 205 and UID 210 are managed logically as a single ONT 230), or the EMS/OLT may communicate directly with the NID 205 and the UID 210 (i.e., the NID 205 and UID 210 are managed as separate devices). These management scenarios cover management categories, including Fault, Configuration, Accounting, Performance, Security (FCAPS), provisioning, alarms and upgrades. Note that in some example embodiments the EMS/OLT may communicate only with the UID 210 as long as it is first communicating with the NID 205.

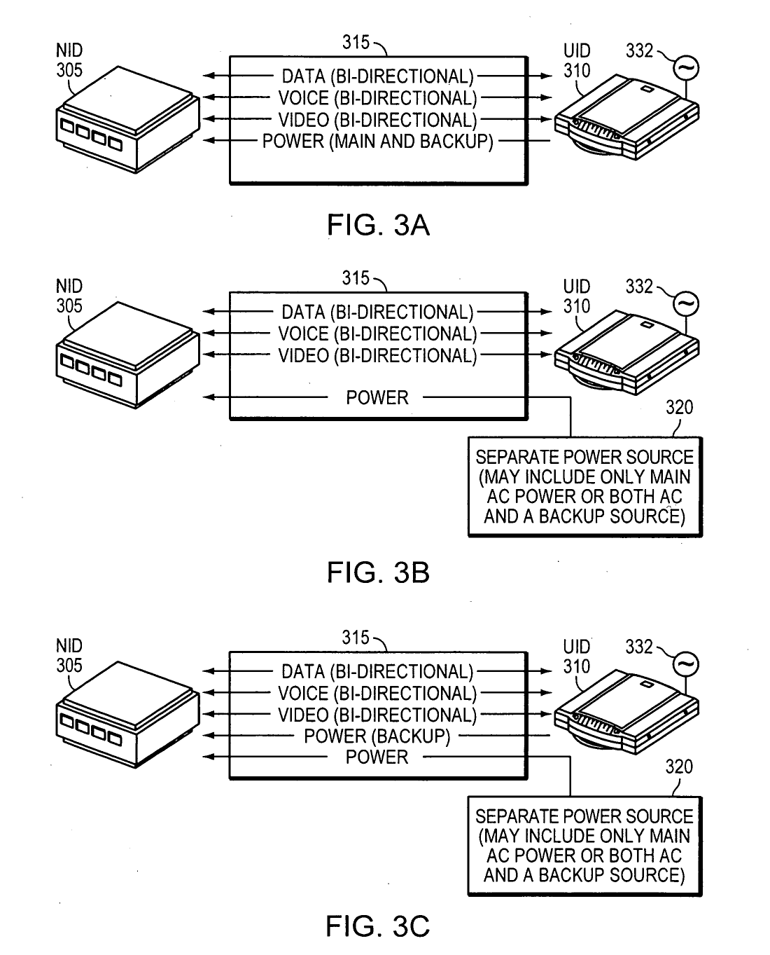

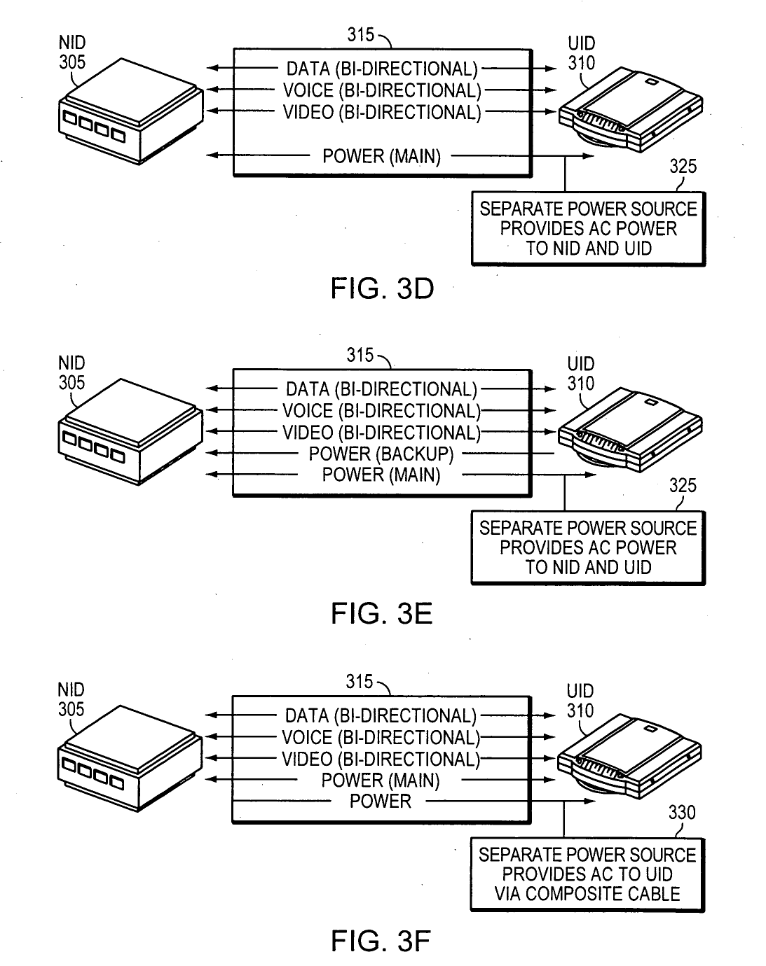

FIGS. 3A-3F are diagrams illustrating example embodiments of the present invention in which a composite cable 315 carries data, voice and video signals, as well as various arrangements of electrical power. As illustrated, electrical power becomes available when the UID 310 is installed and the composite cable 315 is connected between the UID 310 and the NID 305.

FIGS. 3A-3C are diagrams illustrating example embodiments of the present invention in which the UID 310 receives electrical power via its own AC power source 332. In FIG. 3A, the UID 310 provides electrical power from its power source 332 to the NID 305 via the composite cable 315, including battery backup power provided to the UID 310 when the AC main power 332 becomes unavailable. In FIGS. 3B-3C, a separate power source 305 connected to the composite cable provides power to the NID 305, which may include main AC power, backup power or both. In FIG. 3C, the UID 310 additionally provides battery backup power to the NID 305 via the composite cable 315 when the AC main power 305 becomes unavailable.

FIGS. 3D-3F are diagrams illustrating example embodiments of the present invention in which the UID 310 receives electrical power via a separate power source 310 connected to the composite cable 315. In FIGS. 3D-3E, the separate power source 310 also provides AC power to the NID 305. In FIG. 3E, the UID 310 also provides backup power to the NID 305 via the composite cable 315. In FIG. 3F, the UID 310 provides electrical power to the NID 305 via the composite cable 315.

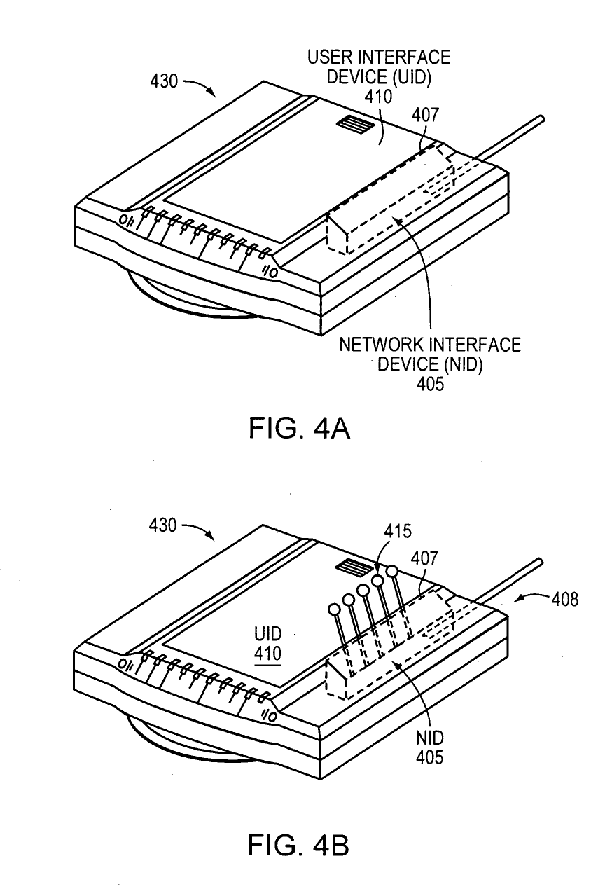

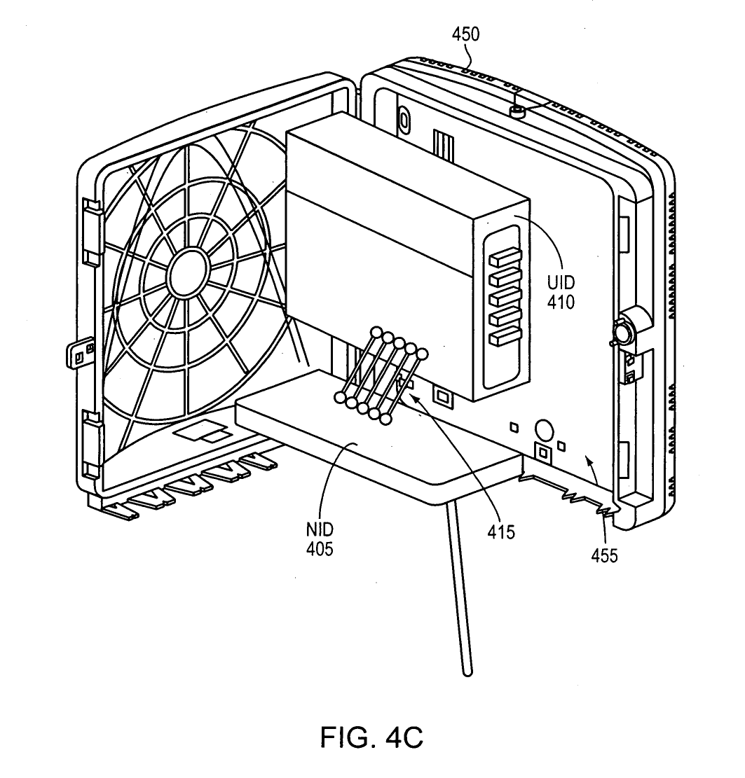

There are various configurations in which the NID 305 and UID 310 may be packaged. In addition to the separate installation locations (e.g., indoor and outdoor) as discussed above, as illustrated in FIG. 4A, the NID 405 and UID 410 may be packaged as a single ONT 430. In this example embodiment, although the NID 405, or an internal optical device 407 of the NID 405, is removed from the NID 405, the NID 405 is physically connected to the UID 410, so they both reside in a single location (e.g., outside or inside an installation premises), and they are still functionally independent. Thus, for example, the optical device 407 may be removed from the NID 405 and physically connected to the UID 410. In this example, the optical device 407 may have a female connector corresponding to a male connector on the UID 410 for insertion or connection to the UID 410.

Alternatively, as illustrated in FIG. 4B, the optical device 407 of the NID 405 may be physically collocated with the UID 410 with one of the composite cable connections described above with reference to FIGS. 3A-3F. In this case, the UID 410 may have a compartment 408 that can accommodate the optical device 407 of the NID 405 and a composite cable 415, which are connected to the NID 405 and also internally connected to the UID 410. If a service provider desires to remove or replace the NID 405, then the cable 415 may stay attached.

In a further example embodiment, as illustrated in FIG. 4C, a traditional ONT 450 enclosure may have a special compartment 405 or location that can accommodate the NID 405 and UID 410, connected by a composite cable 415.

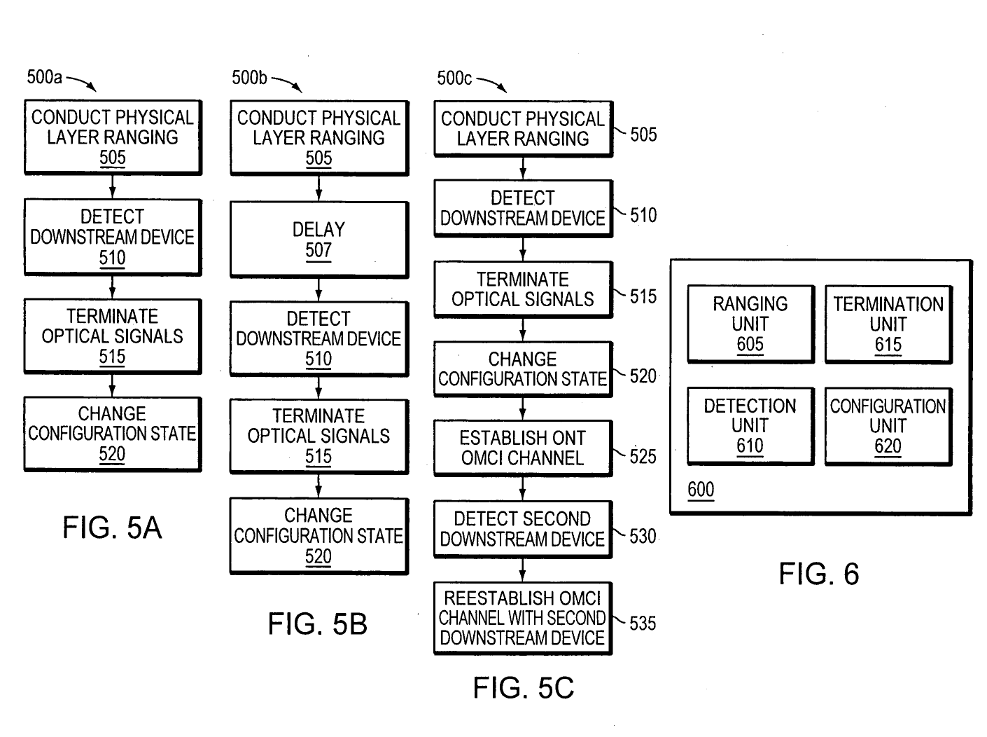

FIG. 5A is a flow diagram 500a illustrating an example method of configuring an ONT. First, physical layer ranging with an upstream device (e.g., NID) is conducted 505. Downstream devices (e.g., UID) configured to support transport layer communications with the upstream device and user interface communications with end user devices are then detected 510. Optical signals are terminated to support communications of configuration data between the upstream device and downstream device 515. Finally, a configuration state is changed based on configuration data initiated by the upstream device but presented by the downstream device 520.

FIG. 5B is a flow diagram 500b illustrating an example method of configuring an ONT in which a UID of the ONT may be installed at a time after a time of installation of a NID of the ONT. First, physical layer ranging with an upstream device (e.g., NID) is conducted 505. Then, after a delay 507 (e.g., at a time after a time of installation of the NID), downstream devices configured to support transport layer communications with the upstream device and user interface communications with end user devices are detected 510. Optical signals are terminated to support communications of configuration data between the upstream device and downstream device 515. Finally, a configuration state is changed based on configuration data initiated by the upstream device but presented by the downstream device 520.

FIG. 5C is a flow diagram 500c illustrating an example method of configuring an ONT in which a UID of the ONT may be replaced or upgraded. First, physical layer ranging with an upstream device (e.g., NID) is conducted 505. Downstream devices (e.g., UID) configured to support transport layer communications with the upstream device and user interface communications with end user devices are then detected 510. Optical signals are terminated to support communications of configuration data between the upstream device and downstream device 515. A configuration state is changed based on configuration data initiated by the upstream device but presented by the downstream device 520. An OMCI channel then may be established 525. Later, a second downstream device (e.g., UID) may be detected 530, such as after a replacement or upgrade of a UID. The OMCI channel is then reestablished 535 with the second downstream device.

FIG. 6 is a block diagram illustrating an example apparatus 600 for configuring an ONT. A ranging unit 605 conducts physical layer ranging with an upstream device. A detection unit 610 then detects the presence of a downstream device configured to support transport layer communications with the upstream device and user interface communications with end user devices. A termination unit 615 terminates optical signals to support communications of configuration data between the upstream device and the downstream device. A configuration unit 620 then changes a configuration state based on configuration data initiated by the upstream device but presented by the downstream device.

In most situations, the NID performs the conversion of the 1550 nm optical signal to the radio frequency (RF) quadrature amplitude modulated (QUAM) signal that is utilized for analog video. However, the NID may also convert the 1550 nm signal to a digital format, which may then be reconverted by the to a format such as Internet Protocol Television (IPTV) or a RF video signal.

Example cables that may be used as the composite cable between the NID and UID include Category 7 (CAT-7) cable. CAT-7 cable is a four twisted pair (TP) cable, similar to Category 5 (CAT-5) cable, except that each pair is individually shielded with an aluminum foil, with all four pairs shielded by a tinned copper braid shield. These layers of shielding allow transmission of frequency signals higher than those permitted by CAT-5, for example. Category 8 (CAT-8) cable, which will carry 1.2 MHz signals, may also be used but is not as common as CAT-7. The use of CAT-7 or CAT-8 cable is only an example of a possible solution to implement the Gigabit PON signal transmission. The actual implementation would likely require more than four pairs and may need a special cable and connector.

While this invention has been particularly shown and described with references to example embodiments thereof, it will be understood by those skilled in the art that various changes in form and details may be made therein without departing from the scope of the invention encompassed by the appended claims.

What is claimed is:

1. A method of configuring an Optical Network Terminal (ONT), the method comprising:
conducting physical layer ranging with an upstream device;
detecting presence of a downstream device configured to support transport layer communications with the upstream device and user interface communications with end user devices;
terminating optical signals to support communications of configuration data between the upstream device and the downstream device; and
changing a configuration state based on configuration data initiated by the upstream device but presented by the downstream device.

2. The method of claim 1 wherein the upstream device is an Optical Line Terminal (OLT).

3. The method of claim 1 wherein the physical layer ranging is performed automatically.

4. The method of claim 1 wherein the physical layer ranging is performed responsive to testing the downstream device.

5. The method of claim 1 wherein detecting presence of the downstream device and changing the configuration state are separated in time from the physical layer ranging.

6. The method of claim 1 further comprising:
establishing an ONT Management Control Interface (OMCI) channel;
detecting a second downstream device different from the downstream device; and
reestablishing the OMCI channel with the second downstream device.

7. The method of claim 1 further comprising:
changing the configuration state based on further configuration data initiated by the upstream device, to configure an upgraded downstream device, but presented by the upgraded downstream device.

8. The method of claim 1 further comprising:
receiving electrical power via the downstream device.

9. The method of claim 1 further comprising:
receiving electrical power independent of the downstream device.

10. The method of claim 1 further comprising:
converting data from an optical domain to an electrical domain; and
transmitting the data via a non-fiber medium to the downstream device to support data flow from the upstream device to the end user devices.

11. The method of claim 1 further comprising:
reporting a state of the downstream device in an event of a fault associated with the downstream device, the fault including communications failure with the downstream device.

12. The method of claim 1 wherein terminating includes transmitting the configuration data from an outdoor environment to an indoor environment with respect to a premises where the end user devices are located.

13. An apparatus for configuring an Optical Network Terminal (ONT), the apparatus comprising:
a ranging unit to conduct physical layer ranging with an upstream device;
a detection unit to detect the presence of a downstream device, the downstream device configured to support transport layer communications with the upstream device and user interface communications with end user devices;
a termination unit to terminate optical signals to support communications of configuration data between the upstream device and the downstream device; and
a configuration unit to change a configuration state based on configuration data initiated by the upstream device but presented by the downstream device.

14. The apparatus of claim 13 wherein the upstream device is an Optical Line Terminal (OLT).

15. The apparatus of claim 13 wherein the ranging unit is configured to perform physical layer ranging automatically.

16. The apparatus of claim 13 wherein the ranging unit is configured to perform physical layer ranging responsive to testing the downstream device.

17. The apparatus of claim 13 wherein the configuration unit is configured to change the configuration state and wherein the enabling unit is configured to detect the presence of a downstream device at a time after a time the ranging unit conducts physical layer ranging.

18. The apparatus of claim 13 wherein the ranging unit is configured to establish an ONT Management Control Interface (OMCI) channel and wherein the ranging unit is configured to detect a second downstream device different from the downstream device and to reestablish the OMCI channel with the second downstream device.

19. The apparatus of claim 13 wherein the configuration unit changes the configuration state based on further configuration data initiated by the upstream device, to configure an upgraded downstream device, but presented by the upgraded downstream device.

20. The apparatus of claim 13 wherein the apparatus is configured to receive electrical power via the downstream device.

21. The apparatus of claim 13 wherein the apparatus is configured to receive electrical power independent of the downstream device.

22. The apparatus of claim 16 wherein the termination unit is configured to convert data from an optical domain to an electrical domain and wherein the termination unit is configured to transmit the data via a non-fiber medium to the downstream device to support data flow from the upstream device to the end user devices.

23. The apparatus of claim 13 further comprising:
a reporting unit configured to report a state of the downstream device in an event of a fault associated with the downstream device wherein the fault includes communications failure with the downstream device.

24. The apparatus of claim 13 wherein the termination unit is configured to transmit the configuration data from an outdoor environment to an indoor environment with respect to a premises where the end user devices are located.

25. A system for configuring an Optical Network Terminal (ONT), the system comprising:
an Optical Line Terminal (OLT);
a User Interface Device (UID) of the ONT, the UID configured to support transport layer communications with the OLT and user interface communications with end user devices; and
a Network Interface Device (NID) of the ONT, the NID configured to conduct physical layer ranging with the OLT, detect presence of the UID, terminate optical signals to support communications of configuration data between the OLT and the UID, and change a configuration state based on configuration data initiated by the OLT but presented by the UID.
